(19) United States
(12) Patent Application Publication
(10) Pub. No.: US 2024/0210805 A1
(43) Pub. Date: Jun. 27, 2024

(54) ILLUMINATION SYSTEM AND PROJECTION APPARATUS

(71) Applicant: Coretronic Corporation, Hsin-Chu (TW)

(72) Inventors: Shang-Wei Chen, Hsin-Chu (TW); Ming-Tsung Weng, Hsin-Chu (TW)

(73) Assignee: Coretronic Corporation, Hsin-Chu (TW)

(21) Appl. No.: 18/389,793

(22) Filed: Dec. 20, 2023

(30) Foreign Application Priority Data
Dec. 21, 2022 (CN) 202211649648.2

(51) Int. Cl. G03B 21/20; G02B 27/14; G03B 21/00

(52) U.S. Cl. CPC G03B 21/204; G02B 27/141; G03B 21/005; G03B 21/208

(57) ABSTRACT

An illumination system and a projection apparatus are provided. The illumination system includes a blue light-emitting element, a red light-emitting element, a wavelength conversion device, a dichroic assembly, a first light diffusion element, and a second light diffusion element. The wavelength conversion device includes a reflective region and a wavelength conversion region. The wavelength conversion region is configured to convert a blue light beam emitted by the blue light-emitting element into a green light beam. The dichroic assembly is disposed between the blue light-emitting element and the wavelength conversion device. The first light diffusion element is disposed between the red light-emitting element and the dichroic assembly.

The second light diffusion element has a diffusion region and a non-diffusion region. The diffusion region is located on a transmission path of the blue light beam. The non-diffusion region is located on a transmission path of the green light beam.

### CROSS-REFERENCE TO RELATED APPLICATION

This application claims the priority benefit of Chinese application no. 202211649648.2, filed on Dec. 21, 2022. The entirety of the above-mentioned patent application is hereby incorporated by reference herein and made a part of this specification.

### BACKGROUND

### Technical Field

The disclosure relates to an optical system and an optical apparatus. Particularly, the disclosure relates to an illumination system and a projection apparatus.

### Description of Related Art

With the advancement of display technology, users have increasingly high requirements for a projection apparatus, for example, hope for increasingly high brightness of an image that the projection apparatus can provide. As such, when in use, the projection apparatus is not required to be limited to a low-brightness environment.

One of the necessary components of the projection apparatus is a light valve, which is configured to convert an illumination beam into an image light beam. However, as the brightness of the image is increasing high, if a single light valve is adopted, light energy transmitted on the light valve may be excessively high, causing the temperature of the light valve to exceed the normal operating temperature, and causing the projection apparatus to fail to operate normally.

To improve the brightness of the image, in a projection apparatus, a laser beam emitted to yellow phosphor is adopted to generate a beam of the desired color with high brightness. However, conversion efficiency of the yellow phosphor is relatively adverse. Moreover, since saturation of a red light converted from the yellow phosphor is relatively adverse, the gamut of the image is limited.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides an illumination system that may achieve relatively high brightness, a relatively wide gamut, and relatively high wavelength conversion efficiency.

Other purposes and advantages of the disclosure may be further understood from the technical features of the disclosure.

To achieve one, some, or all of the above purposes or other purposes, an embodiment of the disclosure provides an illumination system. The illumination system includes a blue light-emitting element, a red light-emitting element, a wavelength conversion device, a dichroic assembly, a first light diffusion element, and a second light diffusion element. The blue light-emitting element is configured to emit a blue light beam. The red light-emitting element is configured to emit a red light beam. The wavelength conversion device includes a reflective region and a wavelength conversion region. The reflective region and the wavelength conversion region are sequentially located on a transmission path of the blue light beam. The wavelength conversion region is configured to convert the blue light beam into a green light beam. The dichroic assembly is disposed between the blue light-emitting element and the wavelength conversion device. The first light diffusion element is disposed between the red light-emitting element and the dichroic assembly. The second light diffusion element is disposed on transmission paths of the blue light beam, the red light beam, and the green light beam from the dichroic assembly. The second light diffusion element has a diffusion region and a non-diffusion region. An angle of the non-diffusion region relative to a central axis of the second light diffusion element is greater than an angle of the diffusion region relative to the central axis of the second light diffusion element. The diffusion region is located on the transmission path of the blue light beam. The non-diffusion region is located on the transmission path of the green light beam.

To achieve one, some, or all of the above purposes or other purposes, an embodiment of the disclosure provides a projection apparatus. The projection apparatus includes the above-mentioned illumination system, a prism assembly, a first light valve, a second light valve, and a projection lens. The prism assembly is disposed on transmission paths of the red light beam, the green light beam, and the blue light beam from the second light diffusion element, and has a dichroic film. The dichroic film is configured to transmit the red light beam and the blue light beam to the first light valve. The first light valve is configured to respectively convert the red light beam and the blue light beam into a first image light beam and a second image light beam. The dichroic film is configured to transmit the green light beam to the second light valve. The second light valve is configured to convert the green light beam into a third image light beam. The projection lens is disposed on a transmission path of an image light beam, and configured to project the image light beam out of the projection apparatus. The image light beam includes at least one of the first image light beam, the second image light beam, and the third image light beam.

In an embodiment of the disclosure, the red light beam and the green light beam pass through the non-diffusion region of the second light diffusion element during a first time interval, and the blue light beam passes through the diffusion region of the second light diffusion element during a second time interval.

In an embodiment of the disclosure, the red light beam and the green light beam are respectively transmitted to the first light valve and the second light valve during a first time interval, and the blue light beam is transmitted to the first light valve during a second time interval.

In an embodiment of the disclosure, ratio relationships between the first time interval and the second time interval are 75:25 to 85:15.

In an embodiment of the disclosure, the red light-emitting element is turned off when the reflective region of the wavelength conversion device is located on the transmission path of the blue light beam.

In an embodiment of the disclosure, an angle coverage of the wavelength conversion region relative to a central axis of the wavelength conversion device is 270 degrees to 306 degrees.

In an embodiment of the disclosure, the dichroic assembly includes a first dichroic element and a second dichroic element. The first dichroic element is disposed between the second dichroic element and the wavelength conversion device.

In an embodiment of the disclosure, the first dichroic element has a first region, a second region, and a third region sequentially arranged. Coating properties of the first region are the same as coating properties of the third region. The coating properties of the first region are different from coating properties of the second region.

In an embodiment of the disclosure, the first region and the third region are configured to allow the blue light beam and the red light beam to pass through and reflect the green light beam. The second region is configured to allow the red light beam to pass through and reflect the blue light beam and the green light beam. The second region and the third region are located on a transmission path of the blue light beam from the reflective region of the wavelength conversion device. An area ratio of the second region to the third region is 1:1.

In an embodiment of the disclosure, the second dichroic element is configured to allow the red light beam to pass through and reflect the blue light beam.

In an embodiment of the disclosure, the red light beam emitted by the red light-emitting element is sequentially transmitted to the first light diffusion element, the second dichroic element, the first dichroic element, and the second light diffusion element.

In an embodiment of the disclosure, the red light beam passes through the non-diffusion region of the second light diffusion element.

In an embodiment of the disclosure, the first light diffusion element has a diffusion region.

In an embodiment of the disclosure, the first light diffusion element has a diffusion region and a non-diffusion region. An angle of the diffusion region of the first light diffusion element relative to a central axis of the first light diffusion element is the same as an angle of the wavelength conversion region relative to a central axis of the wavelength conversion device.

In an embodiment of the disclosure, a sum of the angle of the diffusion region relative to the central axis of the second light diffusion element and the angle of the non-diffusion region relative to the central axis of the second light diffusion element is 360 degrees.

In an embodiment of the disclosure, the non-diffusion region comprises a reflective layer, configured to reflect the blue light beam.

Based on the foregoing, the embodiment of the disclosure has at least one of the following advantages or effects. In the illumination system and the projection apparatus of the embodiment of the disclosure, since the wavelength conversion device that converts the blue light beam into the green light beam is adopted, the illumination system and the projection apparatus of the embodiment of the disclosure may achieve relatively high wavelength conversion efficiency and relatively high brightness. Moreover, since the red light beams of the embodiment of the disclosure are all from the red light-emitting element, and the red light beam has relatively high saturation, the illumination system and the projection apparatus of the embodiment of the disclosure may have a relatively wide gamut. In the embodiment of the disclosure, the red light beam and the blue light beam enter the first light valve, and the green light beam enters the second light valve. The loading of light energy withstood by the first light valve and the second light valve may not be excessively high. As a result, the temperature of the projection apparatus may not be excessively high, and the projection apparatus of the embodiment of the disclosure may operate normally and have good image quality.

Other objectives, features and advantages of the present invention will be further understood from the further technological features disclosed by the embodiments of the present invention wherein there are shown and described preferred embodiments of this invention, simply by way of illustration of modes best suited to carry out the invention.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of an illumination system of an embodiment of the disclosure.

FIG. 2 is a schematic view of a projection apparatus of an embodiment of the disclosure.

FIG. 3 is a schematic front view of the wavelength conversion device in FIG. 1.

FIG. 4 is a schematic front view of the second light diffusion element of FIG. 1.

FIG. 5 is a schematic front view of the first light diffusion element of FIG. 1.

FIG. 6 is a schematic front view of the first dichroic element in FIG. 1.

FIG. 7 is a schematic view of the dichroic assembly, the wavelength conversion device, and the lens element in FIG. 1.

FIG. 8 is a timing diagram of the first light valve and the second light valve in FIG. 2.

FIG. 9 is a schematic front view of a first light diffusion element of another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

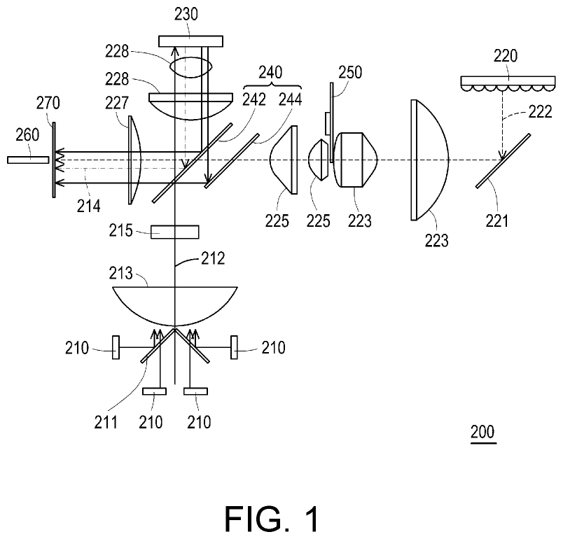

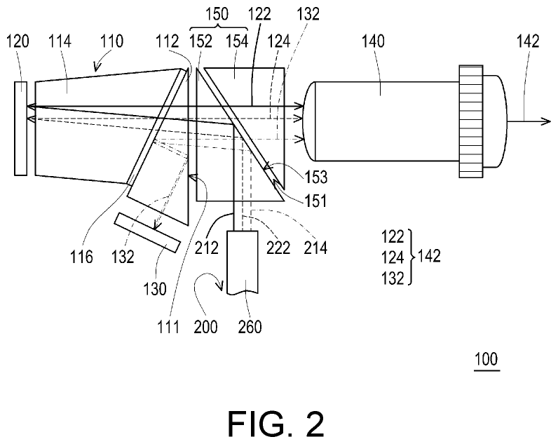

FIG. 1 is a schematic structural view of an illumination system of an embodiment of the disclosure, and FIG. 2 is a schematic view of a projection apparatus of an embodiment of the disclosure. An illumination system 200 of FIG. 2 adopts an illumination system 200 of FIG. 1. With reference to FIG. 1 and FIG. 2, the projection apparatus (projector) 100 of this embodiment includes an illumination system 200, a prism assembly 110, a first light valve 120, a second light valve 130, and a projection lens 140. The illumination system 200 includes at least one blue light-emitting element 210 (a plurality of blue light-emitting elements 210 are taken as an example in FIG. 1), at least one red light-emitting element 220, a wavelength conversion device 230, a dichroic assembly 240, a first light diffusion element 250, and a second light diffusion element 270.

The blue light-emitting element 210 is configured to emit a blue light beam 212, and the red light-emitting element 220 is configured to emit a red light beam 222. In this embodiment, the at least one blue light-emitting element 210 and the at least one red light-emitting element 220 are light-emitting diodes (LED), laser diodes (LD), or a combination thereof or other suitable light sources, for example. In an embodiment, the illumination system 200 may further include a mirror 211, a lens element 213, a fly eye lens element 215, a mirror 221, and a lens element 223. A plurality of blue light beams 212 emitted by the plurality of blue light-emitting elements 210 may be transmitted by the mirror 211, the lens element 213, and the fly eye lens element 215 to the wavelength conversion device 230. A plurality of red light beams 222 emitted by a plurality of red light-emitting elements 220 may be transmitted by the mirror 221 and a plurality of lens elements 223 to the first light diffusion element 250.

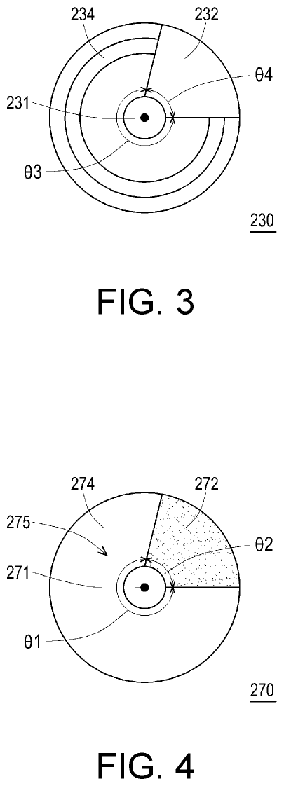

FIG. 3 is a schematic front view of the wavelength conversion device in FIG. 1. With reference to FIG. 1, FIG. 2, and FIG. 3, the wavelength conversion device 230 includes a reflective region 232 and a wavelength conversion region 234. The reflective region 232 and the wavelength conversion region 234 are sequentially located on a transmission path of the blue light beam 212. The wavelength conversion region 234 is configured to convert the blue light beam 212 into a green light beam 214. In this embodiment, the wavelength conversion device 230 is a rotating wheel, for example, and the wavelength conversion region 234 is coated with green phosphor. When the wavelength conversion region 234 moves to the transmission path of the blue light beam 212 due to the rotation of the rotating wheel, the blue light beam 212 excites the green phosphor, such that the green phosphor generates the green light beam 214. The peak of the spectrum of the green light beam 214 ranges from 515 nanometers (nm) to 535 nm, for example. When the reflective region 232 moves to the transmission path of the blue light beam 212 due to the rotation of the rotating wheel, the reflective region 232 reflects the blue light beam 212. The reflective region 232 includes a mirror or a reflective layer, for example.

The dichroic assembly 240 is disposed between the blue light-emitting element 210 and the wavelength conversion device 230. The first light diffusion element 250 is disposed between the red light-emitting element 220 and the dichroic assembly 240. The second light diffusion element 270 is disposed on transmission paths of the blue light beam 212, the red light beam 222, and the green light beam 214 from the dichroic assembly 240. In an embodiment, the illumination system 200 further includes a light homogenizing element 260, and the second light diffusion element 270 is disposed between the dichroic assembly 240 and the light homogenizing element 260.

FIG. 4 is a schematic front view of the second light diffusion element of FIG. 1. With reference to FIG. 1 to FIG. 4, the second light diffusion element 270 has a diffusion region 272 and a non-diffusion region 274. An angle θ1 of the non-diffusion region 274 relative to a central axis 271 of the second light diffusion element 270 is greater than an angle θ2 of the diffusion region 272 relative to the central axis 271 of the second light diffusion element 270. The diffusion region 272 is located on the transmission path of the blue light beam 212, and the non-diffusion region 274 is located on the transmission path of the green light beam 214. In this embodiment, the second light diffusion element 270 is a rotating wheel. A sum of the angle θ2 of the diffusion region 272 relative to the central axis 271 of the second light diffusion element 270 and the angle θ1 of the non-diffusion region 274 relative to the central axis 271 of the second light diffusion element 270 is 360 degrees. In this embodiment, the angle θ2 of the diffusion region 272 relative to the central axis 271 of the second light diffusion element 270 is equal to an angle θ4 of the reflective region 232 relative to a central axis 231 of the wavelength conversion device 230, and the angle θ1 of the non-diffusion region 274 relative to the central axis 271 of the second light diffusion element 270 is equal to an angle θ3 of the wavelength conversion region 234 relative to the central axis 231 of the wavelength conversion device 230. When the reflective region 232 moves to the transmission path of the blue light beam 212 and reflects the blue light beam 212, the diffusion region 272 moves to the transmission path of the blue light beam 212 reflected from the reflective region 232. A haze value of the diffusion region 272 is greater than 0 and the diffusion region 272 is configured to diffuse the blue light beam 212, and the speckle may be suppressed. When the wavelength conversion region 234 moves to the transmission path of the blue light beam 212 and converts the blue light beam 212 into the green light beam 214, the non-diffusion region 274 moves to the transmission path of the green light beam 214. The non-diffusion region 274 has no haze and is configured to allow the green light beam 214 to pass through.

In this embodiment, an angle coverage (i.e., the range of the angle θ3) of the wavelength conversion region 234 relative to the central axis 231 of the wavelength conversion device 230 is 270 degrees to 306 degrees, or ranging from 279 degrees to 296 degrees. An angle coverage (i.e., the range of the angle θ4) of the reflective region 232 relative to the central axis 231 of the wavelength conversion device 230 is 54 degrees to 90 degrees, or ranging from 64 degrees to 81 degrees. An angle coverage (i.e., the range of the angle θ1) of the non-diffusion region 274 relative to the central axis 271 of the second light diffusion element 270 is 270 degrees to 306 degrees, or ranging from 279 degrees to 296 degrees. An angle coverage (i.e., the range of the angle θ2) of the diffusion region 272 relative to the central axis 271 of the second light diffusion element 270 is 54 degrees to 90 degrees, or ranging from 64 degrees to 81 degrees.

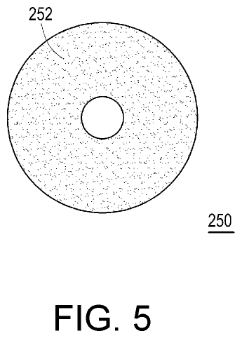

FIG. 5 is a schematic front view of the first light diffusion element of FIG. 1. With reference to FIG. 1, FIG. 2, and FIG. 5, in this embodiment, the first light diffusion element 250 has a diffusion region 252. The diffusion region 252 has haze and is configured to diffuse the red light beam 222 to suppress speckle. In this embodiment, the first light diffusion element 250 is a rotating wheel, and the diffusion region 252 is ring-shaped. Since the diffusion region 252 is ring-shaped, the diffusion region 252 has a simple manufacturing process. In another embodiment, the first light diffusion element 250 may also be a diffusion sheet that is fixed (i.e., does not rotate or move). Since the diffusion region 252 is sheet-shape, the diffusion region 252 has a simple manufacturing process.

In an embodiment, the light homogenizing element 260 is a light integration rod, for example, and is configured to homogenize the red light beam 222, the green light beam 214, and the blue light beam 212. In other embodiments, the light homogenizing element 260 may also be a lens array.

The prism assembly 110 is disposed on a transmission path of the red light beam 222, the green light beam 214, and the blue light beam 212 from the second light diffusion element 270. The prism assembly 110 has a dichroic film 116. The dichroic film 116 is configured to transmit the red light beam 222 and the blue light beam 212 to the first light valve 120. The first light valve 120 is configured to respectively convert the red light beam 222 and the blue light beam 212 into a first image light beam 122 and a second image light beam 124. The dichroic film 116 is configured to transmit the green light beam 214 to the second light valve 130. The second light valve 130 is configured to convert the green light beam 214 into a third image light beam 132. The projection lens 140 is disposed on a transmission path of an image light beam 142, and is configured to project the image light beam 142 out of the projection apparatus 100 to form a projection light beam projected onto a projection target (not shown). The projection target is a screen or a wall, for example. The image light beam 142 includes at least one of the first image light beam 122, the second image light beam 124, and the third image light beam 132.

In this embodiment, the projection lens 140 is one optical lens element or a combination of more optical lens elements having refractive power, for example. For example, the optical lens element includes various combinations of non-planar lens elements, such as a biconcave lens element, a biconvex lens element, a concavo-convex lens element, a convexo-concave lens element, a plano-convex lens element, and a plano-concave lens element.

In this embodiment, the first light valve 120 and the second light valve 130 are digital micro-mirror devices (DMD), for example. In other embodiments, the first light valve 120 and the second light valve 130 may also be liquid-crystal-on-silicon panels (LCOS panels). In this embodiment, the prism assembly 110 further has a prism 112 and a prism 114, and the dichroic film 116 is disposed between the prism 112 and the prism 114.

In an embodiment, the red light beam 222, the green light beam 214, and the blue light beam 212 homogenized from the light homogenizing element 260 are first transmitted to a total internal reflection prism 150. The total internal reflection prism includes a prism 152 and a prism 154. There is an air gap 151 between the prism 152 and the prism 154. A surface 153 of the prism 152 facing the air gap 151 is a total internal reflection surface. After entering the prism 152, the red light beam 222, the green light beam 214, and the blue light beam 212 are totally internally reflected by the surface 153 to the prism assembly 110. Then, the red light beam 222 and the blue light beam 212 sequentially pass through the prism 112, the dichroic film 116, and the prism 114 and are transmitted to the first light valve 120. The first image light beam 122 and the second image light beam 124 converted by the first light valve 120 sequentially pass through the prism 114, the dichroic film 116, the prism 112, the prism 152, the air gap 151, and the prism 154 and are transmitted to the projection lens 140. After entering the prism 112, the green light beam 214 is sequentially reflected by the dichroic film 116, reflected by a surface 111 of the prism 112, and transmitted to the second light valve 130. The third image light beam 132 converted by the second light valve 130 sequentially enters the prism 112, is reflected by the surface 111, and is reflected by the dichroic film 116. Then, the third image light beam 132 sequentially passes through the surface 111, the prism 152, the air gap 151, and the prism 154 and is transmitted to the projection lens 140. In other words, the dichroic film 116 is adapted to allow red light (the red light beam 222 and the first image light beam 122) and blue light (the blue light beam 212 and the second image light beam 124) to pass through, and the dichroic film 116 is adapted to reflect green light (the green light beam 214 and the third image light beam 132).

In an embodiment, it is possible to use a dichroic film 116 having other coating properties, for example, a dichroic film 116 adapted to allow green light (the green light beam 214 and the third image light beam 132) to pass through, and adapted to reflect red light (the red light beam 222 and the first image light beam 122) and blue light (the blue light beam 212 and the second image light beam 124).

In the illumination system 200 and the projection apparatus 100 of this embodiment, since the wavelength conversion device 230 that converts the blue light beam 212 into the green light beam 214 is adopted, the illumination system 200 and the projection apparatus 100 of this embodiment may achieve relatively high wavelength conversion efficiency. The wavelength conversion device 230 of this embodiment adopts green phosphor, and the wavelength conversion efficiency of green phosphor is greater than the wavelength conversion efficiency of yellow phosphor, so the conversion efficiency of converting the blue light beam 212 into the green light beam 214 may be effectively improved, achieving relatively high brightness. For example, the projection apparatus 100 of this embodiment may achieve brightness as high as 40,000 lumens. Moreover, with brightness of 30,000 lumens or more, the light-emitting power of the blue light-emitting element 210 may be reduced by 5% or more, which effectively saves energy. Since the red light beam 222 of this embodiment are all from the red light-emitting element 220 instead of being generated by yellow phosphor, the red light beam 222 of this embodiment has relatively high color purity and may have a relatively wide gamut. In BT.2020, the gamut may reach 67.5% (which is 4% to 5% more than the 63% achieved by red light with relatively low saturation generated by yellow phosphor).

In this embodiment, the dichroic assembly 240 includes a first dichroic element 242 and a second dichroic element 244. The first dichroic element 242 is disposed between the second dichroic element 244 and the wavelength conversion device 230.

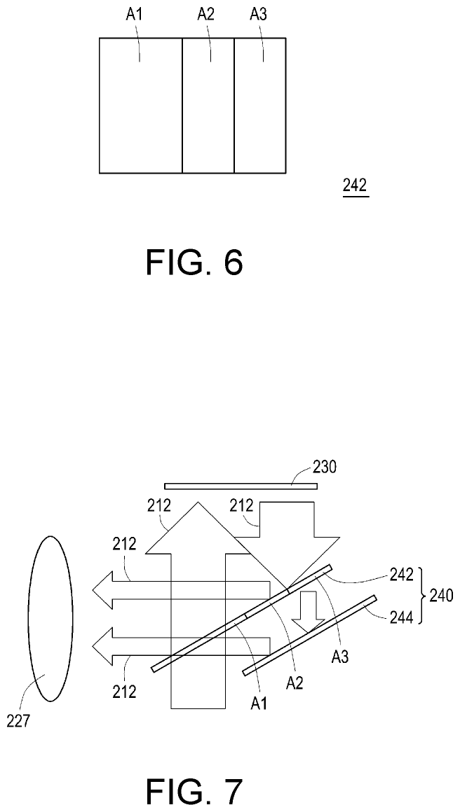

FIG. 6 is a schematic front view of the first dichroic element in FIG. 1, and FIG. 7 is a schematic view of the dichroic assembly, the wavelength conversion device, and the lens element in FIG. 1. With reference to FIG. 1, FIG. 6, and FIG. 7, the first dichroic element 242 has a first region A1, a second region A2, and a third region A3 sequentially arranged. The first dichroic element 242 is coated with dichroic films on surfaces of the first region A1, the second region A2, and the third region A3. Coating properties of the first region A1 are the same as coating properties of the third region A3, and the coating properties of the first region A1 are different from coating properties of the second region A2. The first dichroic element 242 is a beam splitter, for example.

Specifically, the first region A1 and the third region A3 are configured to allow the blue light beam 212 and the red light beam 222 to pass through and reflect the green light beam 214, and the second region A2 is configured to allow the red light beam 222 to pass through and reflect the blue light beam 212 and the green light beam 214. The first region A1 is located on the transmission path of the blue light beam 212 from the blue light-emitting element 210, and the second region A2 and the third region A3 are located on the transmission paths of the blue light beam 212 and the green light beam 214 from the wavelength conversion device 230. FIG. 7 is a schematic view of the dichroic assembly 240 and the blue light beam 212. In an embodiment, an area ratio of the second region A2 to the third region A3 is 1:1. Since the second region A2 is configured to reflect the blue light beam 212, and the third region A3 is configured to allow the blue light beam 212 to pass through, the uniform distribution of the blue light beam(s) 212 may be achieved accordingly. In addition, the second dichroic element 244 is configured to allow the red light beam 222 to pass through and reflect the blue light beam 212. The second dichroic element 244 is a beam splitter, for example.

In this embodiment, the red light beam 222 emitted by the red light-emitting element 220 is sequentially transmitted to the first light diffusion element 250, the second dichroic element 244, the first dichroic element 242, and the second light diffusion element 270. The red light beam 222 passes through the non-diffusion region 274 of the second light diffusion element 270. In this embodiment, the non-diffusion region 274 may include a reflective layer 275, configured to reflect the blue light beam 212 that has not been converted by the wavelength conversion region 234, and allow the red light beam 222 and the green light beam 214 to pass through to prevent speckle from being caused and prevent stray light from entering subsequent optical elements (e.g., the light homogenizing element 260). In an embodiment, the reflection band of the reflective layer 275 of the non-diffusion region 274 configured to reflect the blue light beam 212 includes a range of 450 nm to 460 nm, for example.

FIG. 8 is a timing diagram of the first light valve and the second light valve in FIG. 2. With reference to FIG. 1, FIG. 2, and FIG. 8, in this embodiment, the red light beam 222 and the green light beam 214 pass through the non-diffusion region 274 of the second light diffusion element 270 during a first time interval T1, and the blue light beam 212 passes through the diffusion region 272 of the second light diffusion element 270 during a second time interval T2.

In this embodiment, the red light beam 222 and the green light beam 214 are respectively transmitted to the first light valve 120 and the second light valve 130 during the first time interval T1, and the blue light beam 212 is transmitted to the first light valve 120 during the second time interval T2. In an embodiment, ratio relationships between the first time interval T1 and the second time interval T2 are 75:25 to 85:15, or 77:23 to 83:17. The first time interval T1 is not overlapped with the second time interval T2. In this embodiment, the red light-emitting element 220 is turned off when the reflective region 232 of the wavelength conversion device 230 is located on (or moves to) the transmission path of the blue light beam 212 (during the second time interval T2). The blue light emitting element 210 is continuously turned on, that is, continuously emits the blue light beam 212, during the first time interval T1 and the second time interval T2.

During the first time interval T1, the blue light beam 212 emitted by the blue light-emitting element 210 sequentially passes through the first region A1 of the first dichroic element 242 and the lens element 228, is transmitted to the wavelength conversion region 234 of the wavelength conversion device 230, and is converted into the green light beam 214 by the wavelength conversion region 234. The green light beam 214 sequentially passes through the lens element 228, is reflected by the second region A2 and the third region A3 of the first dichroic element 242, passes through the lens element 227, passes through the non-diffusion region 274 of the second light diffusion element 270, and passes through the light homogenizing element 260 and is transmitted to the second light valve 130. Similarly, during the first time interval T1, the red light beam 222 emitted by the red light-emitting element 210 sequentially passes through the first light diffusion element 250, the second dichroic element 244, the first dichroic element 242, the lens element 227, the non-diffusion region 274 of the second light diffusion element 270, and the light homogenizing element 260 and is transmitted to the first light valve 120. In this embodiment, the time when the red light beam 222 is incident on the first light valve 120 is the same as the time when the green light beam 214 is incident on the second light valve 130.

During the second time interval T2, the red light-emitting element 210 is turned off, and the blue light beam 212 emitted by the blue light-emitting element 210 sequentially passes through the first region A1 of the first dichroic element 242 and the lens element 228, is transmitted to the reflective region 232 of the wavelength conversion device 230, and is reflected by the reflective region 232. A part of the blue light beam 212 reflected by the reflective region 232 is reflected by the second region A2 of the first dichroic element 242 to the lens element 227, and another part of the blue light beam 212 reflected by the reflective region 232 sequentially passes through the third region A3 of the first dichroic element 242, is reflected by the second dichroic element 244, and passes through the first region A1 of the first dichroic element 242 and is transmitted to the lens element 227. Then, the blue light beam 212 sequentially passes through the lens element 227, the diffusion region 272 of the second light diffusion element 270, and the light homogenizing element 260 and is transmitted to the first light valve 120.

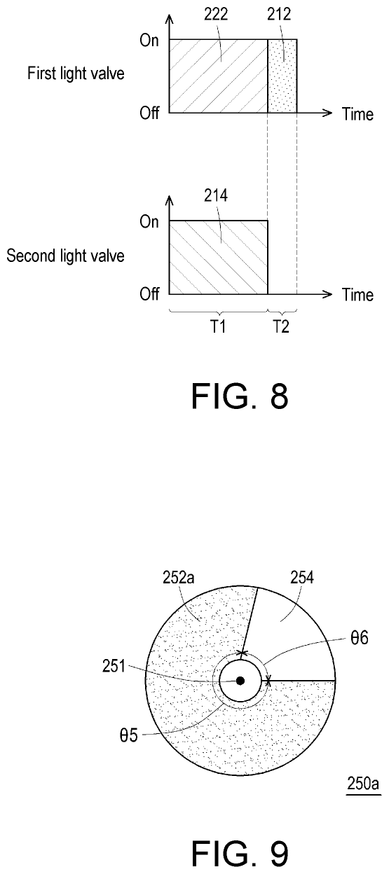

FIG. 9 is a schematic front view of a first light diffusion element of another embodiment of the disclosure. With reference to FIG. 1, FIG. 5, and FIG. 9, the difference between the first light diffusion element of this embodiment and the first light diffusion element 250 of FIG. 5 is that a first light diffusion element 250a of this embodiment has a diffusion region 252a and a non-diffusion region 254. An angle θ5 of the diffusion region 252a of the first light diffusion element 250a relative to a central axis 251 of the first light diffusion element 250a is the same as the angle θ3 of the wavelength conversion region 234 relative to the central axis 231 of the wavelength conversion device 230. An angle θ6 of the non-diffusion region 254 of the first light diffusion element 250a relative to the central axis 251 of the first light diffusion element 250a is the same as the angle θ4 of the reflective region 232 relative to the central axis 231 of the wavelength conversion device 230. An angle coverage (i.e., the range of the angle θ5) of the diffusion region 252a relative to the central axis 251 of the first light diffusion element 250a is 270 degrees to 306 degrees, or ranging from 279 degrees to 296 degrees. An angle coverage (i.e., the range of the angle θ6) of the non-diffusion region 254 relative to the central axis 251 of the first light diffusion element 250a is 54 degrees to 90 degrees, or ranging from 64 degrees to 81 degrees. In addition, at the timing when the red light-emitting element 210 is turned on (during the first time interval T1), the diffusion region 252a moves to the transmission path of the red light beam 222 to diffuse the red light beam 222.

In summary of the foregoing, the embodiment of the disclosure has at least one of the following advantages or effects. In the illumination system and the projection apparatus of the embodiment of the disclosure, since the wavelength conversion device that converts the blue light beam into the green light beam is adopted, the illumination system and the projection apparatus of the embodiment of the disclosure may achieve relatively high wavelength conversion efficiency and relatively high brightness. Moreover, since the red light beams of the embodiment of the disclosure are all from the red light-emitting element, and the red light beam has relatively high saturation, the illumination system and the projection apparatus of the embodiment of the disclosure may have a relatively wide gamut. In the embodiment of the disclosure, the red light beam and the blue light beam enter the first light valve, and the green light beam enters the second light valve. The loading of light energy withstood by the first light valve and the second light valve may not be excessively high. As a result, the temperature of the projection apparatus may not be excessively high, and the projection apparatus of the embodiment of the disclosure may operate normally and have good image quality.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a blue light-emitting element, configured to emit a blue light beam;
a red light-emitting element, configured to emit a red light beam;
a wavelength conversion device, comprising a reflective region and a wavelength conversion region, wherein the reflective region and the wavelength conversion region are sequentially located on a transmission path of the blue light beam, and the wavelength conversion region is configured to convert the blue light beam into a green light beam;
a dichroic assembly, disposed between the blue light-emitting element and the wavelength conversion device;
a first light diffusion element, disposed between the red light-emitting element and the dichroic assembly; and
a second light diffusion element, disposed on transmission paths of the blue light beam, the red light beam, and the green light beam from the dichroic assembly, and the second light diffusion element having a diffusion region and a non-diffusion region, wherein an angle of the non-diffusion region relative to a central axis of the second light diffusion element is greater than an angle of the diffusion region relative to the central axis of the second light diffusion element, the diffusion region is located on the transmission path of the blue light beam, and the non-diffusion region is located on the transmission path of the green light beam.

2. The illumination system according to claim 1, wherein an angle coverage of the wavelength conversion region relative to a central axis of the wavelength conversion device is 270 degrees to 306 degrees.

3. The illumination system according to claim 1, wherein the dichroic assembly comprises a first dichroic element and a second dichroic element, wherein the first dichroic element is disposed between the second dichroic element and the wavelength conversion device.

4. The illumination system according to claim 3, wherein the first dichroic element has a first region, a second region, and a third region sequentially arranged, wherein coating properties of the first region are the same as coating properties of the third region, and the coating properties of the first region are different from coating properties of the second region.

5. The illumination system according to claim 4, wherein the first region and the third region are configured to allow the blue light beam and the red light beam to pass through and reflect the green light beam, the second region is configured to be allow the red light beam to pass through and reflect the blue light beam and the green light beam, the second region and the third region are located on a transmission path of the blue light beam from the reflective region of the wavelength conversion device, and an area ratio of the second region to the third region is 1:1.

6. The illumination system according to claim 3, wherein the second dichroic element is configured to allow the red light beam to pass through and reflect the blue light beam.

7. The illumination system according to claim 3, wherein the red light beam emitted by the red light-emitting element is sequentially transmitted to the first light diffusion element, the second dichroic element, the first dichroic element, and the second light diffusion element.

8. The illumination system according to claim 7, wherein the red light beam passes through the non-diffusion region of the second light diffusion element.

9. The illumination system according to claim 1, wherein the first light diffusion element has a diffusion region.

10. The illumination system according to claim 1, wherein the first light diffusion element has a diffusion region and a non-diffusion region, wherein an angle of the diffusion region of the first light diffusion element relative to a central axis of the first light diffusion element is the same as an angle of the wavelength conversion region relative to a central axis of the wavelength conversion device.

11. The illumination system according to claim 1, wherein a sum of the angle of the diffusion region relative to the central axis of the second light diffusion element and the angle of the non-diffusion region relative to the central axis of the second light diffusion element is 360 degrees.

12. The illumination system according to claim 1, wherein the non-diffusion region comprises a reflective layer, configured to reflect the blue light beam.

13. A projection apparatus, comprising:
an illumination system, comprising:
a blue light-emitting element, configured to emit a blue light beam;
a red light-emitting element, configured to emit a red light beam;
a wavelength conversion device, comprising a reflective region and a wavelength conversion region, wherein the reflective region and the wavelength conversion region are sequentially located on a transmission path of the blue light beam, and the wavelength conversion region is configured to convert the blue light beam into a green light beam;
a dichroic assembly, disposed between the blue light-emitting element and the wavelength conversion device;
a first light diffusion element, disposed between the red light-emitting element and the dichroic assembly; and
a second light diffusion element, disposed on transmission paths of the blue light beam, the red light beam, and the green light beam from the dichroic assembly, and the second light diffusion element having a diffusion region and a non-diffusion region, wherein an angle of the non-diffusion region relative to a central axis of the second light diffusion element is greater than an angle of the diffusion region relative to the central axis of the second light diffusion element, the diffusion region is located on the transmission path of the blue light beam, and the non-diffusion region is located on the transmission path of the green light beam;
a prism assembly, disposed on transmission paths of the red light beam, the green light beam, and the blue light beam from the second light diffusion element, and having a dichroic film;
a first light valve, wherein the dichroic film is configured to transmit the red light beam and the blue light beam to the first light valve, and the first light valve is configured to respectively convert the red light beam and the blue light beam into a first image light beam and a second image light beam;
a second light valve, wherein the dichroic film is configured to transmit the green light beam to the second light valve, and the second light valve is configured to convert the green light beam into a third image light beam; and
a projection lens, disposed on a transmission path of an image light beam, and configured to project the image light beam out of the projection apparatus, wherein the image light beam comprises at least one of the first image light beam, the second image light beam, and the third image light beam.

14. The projection apparatus according to claim 13, wherein the red light beam and the green light beam pass through the non-diffusion region of the second light diffusion element during a first time interval, and the blue light beam passes through the diffusion region of the second light diffusion element during a second time interval.

15. The projection apparatus according to claim 13, wherein the red light beam and the green light beam are respectively transmitted to the first light valve and the second light valve during a first time interval, and the blue light beam is transmitted to the first light valve during a second time interval.

16. The projection apparatus according to claim 15, wherein ratio relationships between the first time interval and the second time interval are 75:25 to 85:15.

17. The projection apparatus according to claim 13, wherein the red light-emitting element is turned off when the reflective region of the wavelength conversion device is located on the transmission path of the blue light beam.

18. The projection apparatus according to claim 13, wherein an angle coverage of the wavelength conversion region relative to a central axis of the wavelength conversion device is 270 degrees to 306 degrees.

19. The projection apparatus according to claim 13, wherein the first light diffusion element has a diffusion region and a non-diffusion region, wherein an angle of the diffusion region of the first light diffusion element relative to a central axis of the first light diffusion element is the same as an angle of the wavelength conversion region relative to a central axis of the wavelength conversion device.

20. The projection apparatus according to claim 13, wherein a sum of the angle of the diffusion region relative to the central axis of the second light diffusion element and the angle of the non-diffusion region relative to the central axis of the second light diffusion element is 360 degrees.
